(19) United States
(12) Patent Application Publication
(10) Pub. No.: US 2015/0082781 A1
(43) Pub. Date: Mar. 26, 2015

(54) PNEUMATIC SYSTEM FOR ENGINES

(71) Applicant: ELECTRO-MOTIVE DIESEL, Inc., La Grange, IL (US)

(72) Inventors: Farhan F. Devani, Morton Grove, IL (US); Aaron G. Foege, Westmont, IL (US); Veronica Anne Hannink, Big Rapids, MI (US)

(73) Assignee: ELECTRO-MOTIVE DIESEL, Inc., La Grange, IL (US)

(21) Appl. No.: 14/555,737

(22) Filed: Nov. 28, 2014

(51) Int. Cl. F02B 67/00; F02B 65/00; F16H 35/18

(52) U.S. Cl. CPC F02B 67/00; F16H 35/18; F02B 65/00; F16H 2312/10
USPC 60/327; 60/412

(57) ABSTRACT

A method to rotate crankshaft of an engine via a pneumatic system is disclosed herein. The engine includes a plurality of engine cylinders. The pneumatic system has an air compressor and a plurality of valves. The method includes monitoring angular orientation of the crankshaft and determining the position of the piston of the plurality of engine cylinders. An engine cylinder amongst the plurality of engine cylinders is selected with the piston in one of a power stroke or a compression stroke. A valve corresponding to the engine cylinder is activated. Upon activation of the valve, compressed air is supplied to the engine cylinder by the air compressor. The valve is then deactivated as the piston attains completion of one power stroke or one compression stroke. The activation, supply, and deactivation are sequentially repeated for each of the plurality of engine cylinders, based on predetermined firing order of the engine.

### TECHNICAL FIELD

The present disclosure relates generally to a system to rotate a crankshaft of an engine. More specifically, the present disclosure relates to a pneumatic system to rotate the crankshaft.

### BACKGROUND

Various machines, such as electric locomotives, employ an engine to produce power to run the machine. These engines may often require service and/or repair. Many service and/or repair procedures require the rotation of a crankshaft of the engine. By this means, the crankshaft may be deployed in orientations that enable access to associated components of the engine, for example, a piston. This procedure is generally termed as “barring” and/or “roll-over” of the crankshaft. Barring and/or roll-over of the crankshaft are generally performed by use of dedicated mechanical tools, which couple the crankshaft of the engine and facilitate manual rotation of the crankshaft.

Modern machines have space constraints because of closed packing arrangements of various adjoining components. Therefore, it becomes considerably burdensome to attach mechanical tools to the crankshaft. In instances where a generator is relatively closely coupled to the engine, such as in locomotive engines, space required to mount such mechanical tools is negligible. As a result, components of the machine are generally disassembled from the machine (or engine) before an engagement of the crankshaft is performed. This increases service time and effort, and has a proportional impact on the costs involved.

U.S. Pat. No. 5,997,260 discloses an engine barring adapter attached/mounted on a shaft of an air compressor. The shaft of the air compressor includes an air compressor gear engaged with a crankshaft gear of the crankshaft. The engine barring adapter is mounted on the shaft of the air compressor and includes a tool that engages the end to which the mechanical tool may be mounted to rotate the crankshaft. Although, this reference provides a system to rotate the crankshaft of the engine, no solution is provided to rotate the crankshaft of the engine without the use of mechanical tools.

### SUMMARY OF THE INVENTION

One aspect of the present disclosure is directed to a method to rotate a crankshaft of an engine via a pneumatic system. The engine has a plurality of engine cylinders. Each of the plurality of engine cylinders includes a piston and a connecting rod, which connects the piston to the crankshaft. The pneumatic system includes an air compressor and a plurality of valves. The air compressor is in fluid communication with the plurality of engine cylinders. The valves are correspondingly disposed between the air compressor and the engine cylinders. The method includes monitoring an angular orientation of the crankshaft. Based on the angular orientation of the crankshaft, a position of the piston within the engine cylinders may be determined. Thereafter, an engine cylinder amongst the engine cylinders that has the piston in one of a power stroke or a compression stroke is selected. Next, a valve that corresponds to the engine cylinder is activated. Upon activation of the valve, compressed air is supplied to the engine cylinder by the air compressor. Once the piston of the engine cylinder attains completion of one of the power strokes or the compression strokes, the valve is deactivated. Each of the stages of activation, supply, and deactivation, are sequentially repeated for each of the engine cylinders, based on a predetermined firing order of the engine.

Another aspect of the present disclosure is directed to a pneumatic system to rotate a crankshaft of an engine. The engine has a plurality of engine cylinders. Each of the plurality of engine cylinders includes a piston and a connecting rod attached between the piston and the crankshaft. The pneumatic system includes an air compressor and a plurality of valves. The air compressor is in fluid communication with the plurality of engine cylinders. The valves are disposed between the air compressor and the engine cylinders. Each valve may correspond to at least one of the engine cylinders. The valves may be actuated in a predefined firing order based on an angular orientation of the crankshaft. Further, the actuation of the valves facilitates a supply of compressed air from the air compressor to a corresponding engine cylinder, thereby rotating the crankshaft.

### BRIEF DESCRIPTION OF THE DRAWINGS

FIG. 1 is an exemplary block diagram of an engine that illustrates a pneumatic system to rotate a crankshaft of the engine, in accordance with the concepts of the present disclosure; and

FIG. 2 is a flowchart that depicts an exemplary method of the pneumatic system of FIG. 1, in accordance with the concepts of the present disclosure.

### DETAILED DESCRIPTION

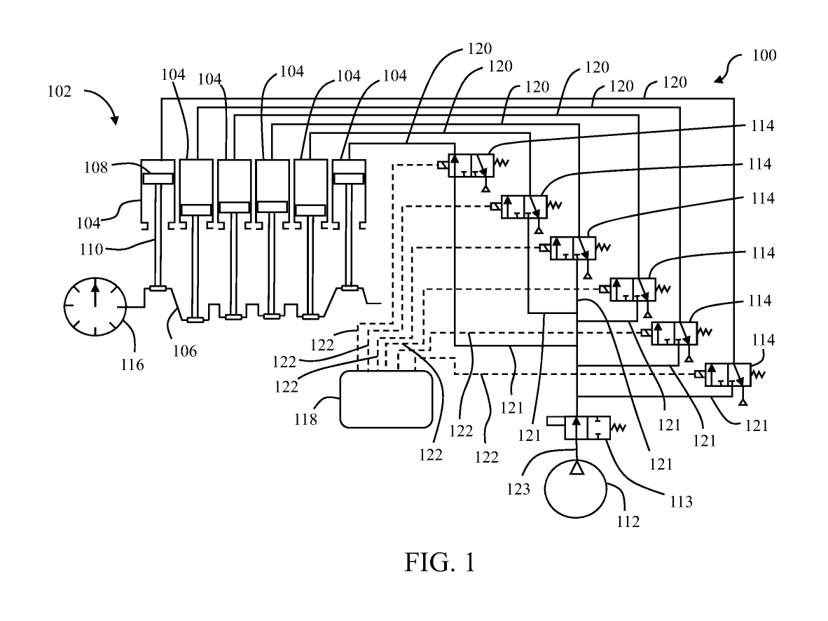

Referring to FIG. 1, there is shown a pneumatic system 100 to rotate various components of an engine 102. The engine 102, may be configured in a machine (not shown) that embodies one of a locomotive, a construction machine, a forest machine, a marine machine, and/or any other similar machine. Applicability to stationary machines, such as power generation systems and other electric power generating machines, may also be envisioned. Further, the concepts of the present disclosure may also be applicable to any machine that utilizes internal combustion engines for varied power generation requirements.

The engine 102 may be one of a spark ignition and/or a compression ignition type. Other engine types may also be contemplated. In an embodiment, a configuration of the engine 102 may constitute one of an ‘In-line layout’ or a ‘V-layout’. The engine 102 may include multiple engine cylinders 104 and a crankshaft 106.

In the current embodiment of disclosure, the engine cylinders 104 are exemplified as six in number. The engine cylinders 104 include closed chambers in which a fuel is delivered to be combusted. By this means, power is produced to operate the engine 102. Each of the engine cylinders 104 includes a piston 108 and a connecting rod 110 that connects the piston 108 to the crankshaft 106. Each piston 108 may be positioned in one of an intake stroke, a compression stroke, a power stroke, and an exhaust stroke. Moreover, it may be noted that a translational movement of the piston 108 corresponds to a rotational movement of the crankshaft 106. The crankshaft 106 may be suitably connected to various other components of the engine 102, for example a camshaft, to impart a proportional movement.

During service and/or repairs, situations may arise that postulate the physical accessibility of one or more of the above noted components. In preferred implementations, this would involve a controlled rotation (barring and/or roll-over) of the crankshaft 106. This may be attained via the pneumatic system 100, as described below.

The pneumatic system 100 may be provided to bar and/or roll over the crankshaft 106, when installed with the engine 102. More particularly, the pneumatic system 100 is adapted to supply compressed air to at least one of the engine cylinders 104 that has the piston 108 in one of the compression stroke and/or the power stroke. Notably, a supply of compressed air to the engine cylinder 104 that has the piston 108 in its power stroke corresponds to rotation of the crankshaft 106 in its normal operating direction. Conversely, a supply of compressed air to the engine cylinder 104 that has the piston 108 in its compression stroke corresponds to rotation of the crankshaft 106 in a direction opposite to the normal operating direction. Moreover, the pneumatic system 100 may supply compressed air to the six engine cylinders 104 in a sequential manner that follows an engine firing order for continuous rotation of the crankshaft 106. A sequential supply of compressed air to the all the six engine cylinders 104 oriented in power stroke results in one complete rotation of the crankshaft 106 in the normal operating direction. Also, a sequential supply of compressed air to the all the six engine cylinders 104 oriented in compression stroke results in one complete rotation of the crankshaft 106 in a direction opposite to the normal operating direction. Although, the exemplary embodiment discloses an idea of supplying the compressed air to one of the multi-cylinders of the engine 102, other combinations, such as compressed air simultaneously supplied to multi-cylinders, in which the pistons 108 move in the same translational direction, to achieve easier and quicker rotation of the crankshaft 106, may also be contemplated.

The pneumatic system 100 includes an air compressor 112, a main valve 113, multiple valves 114, an engine pointer 116, and a selector switch 118. Fluid communication lines 120, 121, 123 may extend from the air compressor 112 to connect to each of the engine cylinders 104, via the main valve 113 and the valves 114.

The air compressor 112 may be a device that draws air from an external environment, compresses the drawn air, and delivers the air at high pressure as an output, when required. The air compressor 112 may be at least one of a rotary compressor, a screw compressor, a reciprocating compressor, a centrifugal compressor, and/or similar devices. The output of air compressor 112, constitute a delivery of compressed air to each of the engine cylinders 104.

The main valve 113 may be a manually operated normally closed valve that controls the supply of compressed air from the air compressor 112 to other components of the pneumatic system 100. The main valve 113 is disposed between the air compressor 112 and the valves 114 and is adapted to operate in an open position and a normally closed position. In the open position, the main valve 113 allows a supply of compressed air from the air compressor 112 to the valves 114. In the normally closed position, the main valve 113 restricts the supply of compressed air from the air compressor 112 to the valves 114.

The valves 114 may be solenoid-operated disposed between the main valve 113 and the engine cylinders 104. The valves 114 facilitate a controlled delivery of compressed air from the air compressor 112 to the engine cylinders 104 through the main valve 113. Each of the valves 114 may respectively correspond to each of the engine cylinders 104. Accordingly, there may be six valves 114 to correspond to each of the engine cylinders 104, as shown in FIG. 1. The valves 114 may operate in one of an extended position and a retracted position. When in the extended position, the valves 114 facilitate a supply of compressed air from the air compressor 112 to the respective engine cylinders 104. When in the retracted position, the valves 114 facilitate vent out of the compressed air already present in the engine cylinders 104, as well as additional air displaced by the movement of the piston 108 through subsequent crankshaft rotation, to the external environment. The high pressure air from the downstream of valve 114, exerts a pressure on the corresponding piston 108 of the engine cylinder 104, causing the piston 108 to move from its top dead center (TDC) to towards the bottom dead center (BDC). A controlled rotational movement of the crankshaft 106 may be achieved by this configuration.

In an embodiment, a singular valve may be selectively connected to each of the engine cylinders 104 and may be configured to perform the function of each of the valves 114. In such cases, known systems may be positioned proximal to and in connection with the affiliated fluid communication line 120. This connection selectively channels and/or varies air delivery into each of the engine cylinders 104.

The engine pointer 116 is connected to the crankshaft 106 to denote the angular orientation of the crankshaft 106. The engine pointer 116 may be at least one of an analog-based device or a digital-based device that may continuously monitor the angular orientation of the crankshaft 106. Known connecters may be disposed to have the engine pointer 116 operably linked with the crankshaft 106 for related angular measurements. Threaded, luer-lock, snap-fit, keyway joints, and/or similar connections are also contemplated, to establish such a link In an embodiment, the engine pointer 116 is connected to the engine's flywheel (not shown) or to other rotatable devices connected to the engine 102 that help determine the angular orientation of the crankshaft 106. By monitoring the angular orientation of the crankshaft 106, a corresponding position and state of the pistons 108 may be determined.

The selector switch 118, is controllably connected to the valves 114 via cabled wires 122. The selector switch 118 is adapted to selectively switch the valves 114 between the extended position and the retracted position. In the current embodiment, the selector switch 118 is electrically controllable to provide input to the valves 114 based on the angular orientation of the crankshaft 106. The selector switch 118 may be manually controlled by an operator sitting in vicinity of the engine pointer 116. In the manually controlled mode, the operator may observe the engine pointer 116, determine the angular orientation of the crankshaft 106, and correspondingly actuate the valves 114. In an exemplary embodiment, the selector switch 118 is operably connected to the engine pointer 116, to automatically receive input from the engine pointer 116. More particularly, the engine pointer 116 provides data that corresponds to the angular orientation of the crankshaft 106 and accordingly the selector switch 118 adjusts the valves 114 based on the data received.

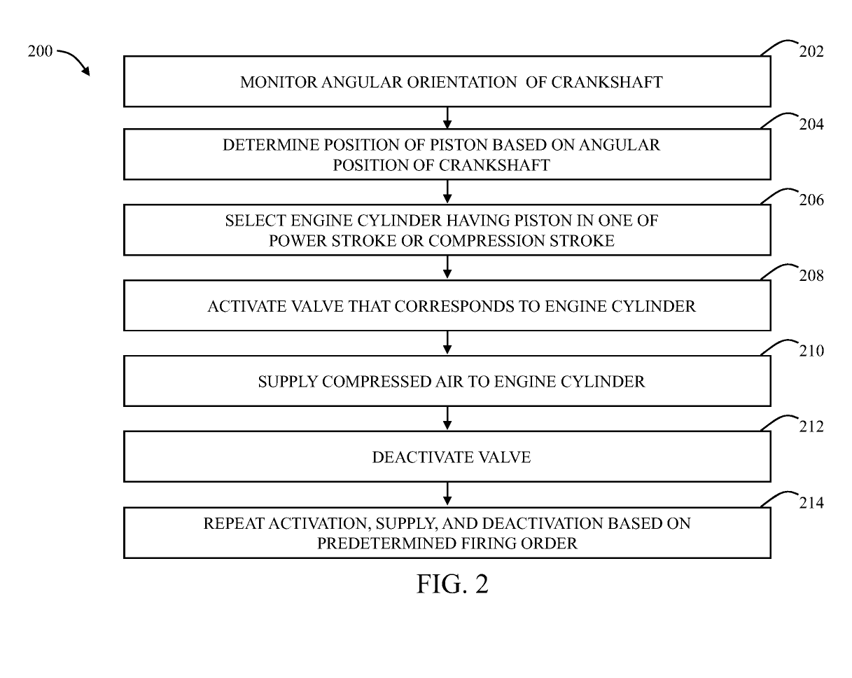

Referring to FIG. 2, an exemplary method in connection with the pneumatic system 100 set out above is provided. The method may be manually operated and is described by means of a flowchart 200, as shown.

The method initiates at step 202. At step 202, the engine pointer 116 monitors the angular orientation of the crankshaft 106. The method proceeds to step 204.

At step 204, a position of the piston 108 within the engine cylinders 104 is determined based on the monitored angular orientation of the crankshaft 106. The method proceeds to step 206.

At step 206, an operator may select an engine cylinder 104 amongst the engine cylinders 104 that has the piston 108 in one of a power stroke or a compression stroke. Additionally, the operator may activate the main valve 113 to open position to allow a supply of compressed air from the air compressor 112 to the valves 114. The method proceeds to step 208.

At step 208, the operator may activate a valve 114 amongst the valves 114 that correspond to the selected engine cylinder 104 using the selector switch 118. The activation may correspond to the extended position of the valve 114 from the retracted position. The method proceeds to step 210.

At step 210, the extended position of the valve 114 may facilitate a supply of compressed air from the air compressor 112 to the selected engine cylinder 104. The method proceeds to step 212.

At step 212, the selector switch 118 may deactivate the valve 114, and thereby, may halt a supply of compressed air into the selected engine cylinder 104. At this stage, the piston 108, within the selected engine cylinder 104, which received the supply of the compressed air, may have reached the bottom dead center (BDC) of the engine cylinder 104. The method proceeds to end step 214.

At end step 214, an operator may sequentially repeat the stages of activation, supply and deactivation (or steps 208, 210, and 212) on the remainder of the engine cylinders 104 that are due to receive a compressed air supply and a corresponding service. This sequential repetition of the described stages may occur based on a predetermined firing order of the engine 102. This facilitates continuous rotation of the crankshaft 106. However, as the crankshaft 106 reaches a desired angular orientation, the operator may deactivate the main valve 113, returning it to the normally closed position. In the normally closed position, the main valve 113 discontinues the supply of compressed air to the valves 114, thereby restricting further movement of the crankshaft 106. Hence, the crankshaft 106 is oriented and locked in the desired angular orientation.

### INDUSTRIAL APPLICABILITY

Service and repair procedures may require an operator to access the components within the engine 102. For example, an overhauling operation may require the piston 108 (and/or other affiliated components) to be removed, cleaned, and re-assembled. Given the firing order of the engine 102, pistons 108 are generally variably oriented (or positioned) within the engine cylinders 104. Accordingly, each piston 108 may require to be manipulated individually to attain suitable access.

In operation, an operator may lock the crankshaft 106 in one of a set position or orientation and connects the pneumatic system 100 with the engine 102. It may be noted that the pneumatic system 100 may be connected to a slot provided within the engine 102 that connects the pneumatic system 100 to the engine cylinders 104. The slot of the engine 102 may otherwise be covered and protected using a plug, when the pneumatic system 100 is not in use.

Furthermore, after connecting the pneumatic system 100 with the engine 102, the operator may determine the angular orientation of the crankshaft 106 by observing the engine pointer 116 connected to the crankshaft 106. Once the angular orientation of the crankshaft 106 is determined, the main valve 113 is actuated to its open position to allow flow of compressed air form the air compressor 112 to the valves 114. Thereafter, depending upon the crankshaft's orientation, the operator may adjust the selector switch 118, to actuate the valve 114 in the extended position that corresponds to the engine cylinder 104 that has the piston 108 in at least one of a compression stroke or a power stroke. Notably, in either of these strokes, the engine cylinder 104 may have the respective intake and exhaust valves in a closed state. Such actuation may facilitate the piston 108 to receive compressed air, which builds pressure that pushes the piston 108 towards the BDC of the engine cylinder 104. A resulting angular movement of the crankshaft 106 is also executed. Thereafter, the valve 114 is retracted or deactivated to cut-off the supply of compressed air. In the retracted position, the valve 114 is open to the external environment, and facilitates bleed out of the compressed air as well as additional air displaced by the movement of the piston 108 through subsequent crankshaft rotation to the external environment.

Subsequently, the valve 114, which corresponds to the engine cylinder 104 and lies next according to the engine firing order, may be actuated. Notably, the next piston 108 within the next engine cylinder 104 is also in one of the compression stroke or the power stroke. A forthcoming flow of compressed air pushes the next piston 108 to the BDC as well. This results in a further movement of the crankshaft 106. Furthermore, it may be noted that while one of the valves 114 is actuated to be in extended position, remaining valves 114 are kept in the retracted position and vent out the compressed air earlier provided as well as additional air displaced by the movement of the piston 108 through subsequent crankshaft rotation to the external environment. In an exemplary embodiment, five valves 114 corresponding to the five engine cylinders 104 (non-active) are disposed in the retracted position while the sixth valve 114 corresponding to the sixth engine cylinder 104 (active) is disposed in the extended position. The sixth valve 114 allows supply of compressed air form the air compressor 112 to the sixth engine cylinder 104 (active). This facilitates rotation of the crankshaft 106 and correspondingly movement of the piston 108 of remaining five engine cylinders 104 (non-active). A corresponding movement of the piston 108 of remaining five engine cylinders 104 (non-active) facilitates entry and/or vent out of the displaced air to the external environment, while the remaining five valves 114 are in retracted position.

Similarly, each piston 108 may be subjected to the sequential flow of compressed air, according to the engine firing order. A service operation may be performed at other cylinder stations that are not currently connected to the pneumatic system 100. Therefore, a sequential actuation of the valves 114 may allow the engine cylinders 104 to receive a sequential supply of compressed air, according to the set firing order of the engine 102. A cycle may be complete when each of the pistons 108 has been subject to the flow of compressed air at least once. The cycle may be repeated, if required. Furthermore, once the crankshaft 106 reaches the desired angular orientation, the main valve 113 may be returned to the normally closed position. Return of the main valve 113 to the normally closed position restricts supply of compressed air form the air compressor 112 to the valves 114. Therefore, no further rotation of the crankshaft 106 may occur. This facilitates locking of the crankshaft 106 to the desired position.

A crankshaft rotational output gained through the delivery of compressed air while the piston 108 is in a compression stroke may differ from when the piston 108 is in the power stroke. In further detail, when a supply of compressed air is facilitated into the engine cylinder 104 that has the piston 108 positioned in a power stroke, a first direction roll (rotation in a normal operating direction) of the crankshaft 106 is enabled. However, when the piston 108 is in a compression stroke state and is subject to a supply of compressed air, a reverse direction roll (rotation in the direction opposite to the normal operating direction) of the crankshaft 106 is enabled. Such a feature may be applicable when the piston 108 or components within any of the engine cylinders 104 require to be accessed repeatedly.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A method of rotating a crankshaft of an engine via a pneumatic system, the engine having a plurality of engine cylinders, each of the plurality of engine cylinders having a piston, and a connecting rod connecting the piston and the crankshaft, the pneumatic system including an air compressor in fluid communication with the plurality of engine cylinders, and a plurality of valves correspondingly disposed between the air compressor and the plurality of engine cylinders, the method including:
monitoring an angular orientation of the crankshaft;
determining a position of the piston of each of the plurality of engine cylinders based on the angular orientation of the crankshaft;
selecting an engine cylinder amongst the plurality of engine cylinders having the piston in one of a power stroke or a compression stroke;
activating a valve that corresponds to the engine cylinder;
supplying compressed air from the air compressor to the engine cylinder;
deactivating the valve as the piston of the engine cylinder attains completion of one of the power stroke or the compression stroke; and
sequentially repeating the activating, supplying, and deactivating, for each of the plurality of engine cylinders based on a predetermined firing order of the engine.

2. A pneumatic system for rotating a crankshaft of an engine, the engine having a plurality of engine cylinders, each of the plurality of engine cylinders including a piston, and a connecting rod attached to the crankshaft, the pneumatic system comprising:
an air compressor in fluid communication with the plurality of engine cylinders; and
a plurality of valves being disposed between the air compressor and the plurality of engine cylinders, each of the plurality of valves corresponds to each of the plurality of engine cylinders, the plurality of valves being actuated in a predefined firing order based on an angular orientation of the crankshaft;
wherein an actuation of the plurality of valves corresponds to a supply of compressed air from the air compressor to a corresponding engine cylinder amongst the plurality of engine cylinders, thereby rotating the crankshaft.
